(19) United States
(12) Patent Application Publication
(10) Pub. No.: US 2005/0139244 A1
(43) Pub. Date: Jun. 30, 2005

(54) Spray lance for a high-pressure cleaning device

(76) Inventor: Thomas Boke, Vlotho (DE)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/024,922

(22) Filed: Dec. 29, 2004

Related U.S. Application Data
(60) Provisional application No. 60/533,003, filed on Dec. 29, 2003.

(30) Foreign Application Priority Data
Jan. 15, 2004 (DE) 20 2004 000 614.6
Mar. 30, 2004 (DE) 20 2004 005 160.5

(51) Int. Cl. B08B 5/04

(52) U.S. Cl. 134/172; 239/587.5

(57) ABSTRACT

A spray lance for a high-pressure cleaning device is proposed with a pivoting nozzle and a support device, as well as an associated link for the spray lance. The spray lance according to the proposal permits universal applicability or easy adaptation to the particular conditions.

### FIELD OF THE INVENTION

The present invention relates to a spray lance for a high-pressure cleaning device, especially for cleaning fluid.

### BACKGROUND OF THE INVENTION

A high-pressure cleaning device in the sense of the present invention is known, e.g., from DE 196 17 778 C2. The high-pressure cleaning device has a feed pump for cleaning fluid. The cleaning fluid of a so-called cleaning or spray lance, which optionally has a valve pistol, can be fed via a pressure line preferably embodied as a hose. On its free end, the spray lance has a nozzle for discharging the cleaning fluid. The cleaning fluid is discharged especially as a stream with a fixed main spraying direction, even if the stream circulates or precedes around so-called rotary nozzles, e.g., for these rotary nozzles inclined to the main spraying direction, and therefore forms a conical spraying pattern.

In practice, it has been shown that the typically elongated spray lance with fixed main spraying direction is not optimally suited to all purposes, e.g., the cleaning of a gutter.

### SUMMARY

The invention is based on the task of providing a spray lance for a high-pressure cleaning device that permits universal applicability.

Another aspect of the present invention is to provide a spray lance for a high-pressure cleaning device that permits easy adaptation to any condition.

Another aspect of the present invention is to provide a spray lance for a high-pressure cleaning device that enables optimal adaptation during cleaning processes.

Another aspect of the present invention is to provide a spray lance for a high-pressure cleaning device that can be guided very easily by a support on a floor surface.

A fundamental idea of the present invention is that the nozzle can pivot about a pivoting axis transverse to the main spraying direction, especially transverse to the longitudinal extension of the spray lance or a handle of the spray lance. This can be realized by a corresponding pivoting holder or bearing of the nozzle and/or by a link in the feed line to the nozzle. This configuration realizes a simple and thus cost-effective construction, wherein the spray lance can be applied universally and also its main spraying direction can be adjusted and especially can be adapted individually to any structural conditions for cleaning purposes.

Another aspect of the present invention, which can also be realized independently, is that the spray lance has a support device, preferably with at least one roller or the like, in the region of its front or free end, so that the spray lance can be supported on a floor surface or other surface, especially with the main spraying direction being directed away from the floor surface. In particular, here the main spraying direction runs at an angle to the longitudinal extension of the spray lance, preferably with the pivoting angle being adjustable. This permits, e.g., simplified cleaning of an underbody of a motor vehicle, in that the spray lance is supported with its free end on a floor surface so that it can move under the vehicle to be cleaned in a desired way and therefore is easy to guide.

### BRIEF DESCRIPTION OF THE DRAWINGS

Additional advantages, features, characteristics, and aspects of the present invention emerge from the claims and the following description of preferred embodiments with reference to the drawings. Shown are:

FIG. 1, a schematic illustration of a high-pressure cleaning device with a spray lance according to the proposal, corresponding to a first embodiment.

FIG. 2, a cross section-like illustration of a front end of the spray lance according to FIG. 1 with a nozzle.

FIG. 3, a schematic illustration of a high-pressure cleaning device with a spray lance according to the proposal with a link according to the proposal, corresponding to a second embodiment;

FIG. 4, a perspective illustration of the link according to the proposal, corresponding to FIG. 3.

FIG. 5, a schematic sectional illustration of the link according to FIG. 3 with a feed line and a nozzle; and

FIG. 6, a schematic illustration of a spray lance according to the proposal with a support device according to a third embodiment.

### DESCRIPTION OF THE SELECTED EMBODIMENT

For the purposes of promoting an understanding of the principles of the invention, reference will now be made to the embodiments illustrated herein and specific language will be used to describe the same. It will nevertheless be understood that no limitation of the scope of the invention is thereby intended. Any alterations and further modifications in the described processes, systems or devices, and any further applications of the principles of the invention as described herein, are contemplated as would normally occur to one skilled in the art to which the invention relates.

In the figures, the same reference symbols are used for equivalent or similar parts, with corresponding or comparable characteristics and advantages being achieved even if, for reasons of simplification, a description is not repeated.

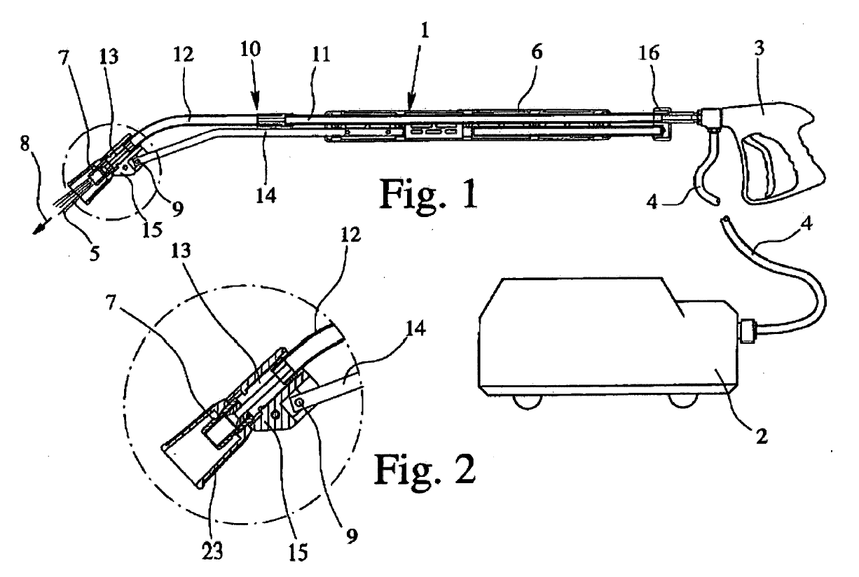

FIG. 1 shows in a schematic illustration a spray lance 1 according to the proposal, which is attached to a high-pressure cleaning device 2. In the shown example, the spray lance 1 is attached or can be attached to the high-pressure cleaning device 2 via an optional valve pistol 3 that can be activated preferably manually and a pressure line 4 formed, in particular, by a hose.

The spray lance 1 is used especially for the discharge of cleaning fluid 5, which can be fed to the spray lance 1 from the high-pressure cleaning device 2 under pressure, heated for improving the cleaning effect of the high-pressure cleaning device 2, if necessary.

The spray lance 1 has a handle 6 and a nozzle 7. During a cleaning process or when the lance is used, the cleaning fluid 5, e.g., water, can be discharged from the nozzle 7 like a stream in the sense mentioned in the introduction, e.g., as a flat stream, conical stream, or pulsed stream, with a main spraying direction 8.

In particular, the spray lance 1 can be plugged into the valve pistol 3 or it can also be connected, if necessary, directly to the pressure line 4. However, another connection, e.g., a screw connection, can also be provided.

According to the proposal, the nozzle 7 can pivot about a pivoting axis 9 transverse, especially perpendicular, to the main spraying direction 8, thus transverse or perpendicular to the longitudinal extension of the spray lance 1 or the handle 6. In particular, this enables universal adaptability of the main spraying direction 8 to the appropriate conditions for cleaning.

In the shown example, the pivoting axis 9 runs adjacent to the nozzle 7 or optionally through this nozzle.

Preferably, the nozzle 7 can pivot only to a limited degree, so that the main spraying direction 8 cannot point towards the handle 6. This is used for protecting a user, not shown.

Preferably, the nozzle 7 can pivot through a maximum of 140°, preferably up to approximately 120°, and/or at least 90°, preferably more than 100°, starting from the main spraying direction 8 when the nozzle 7 is not pivoted.

Preferably, the nozzle 7 can pivot continuously. However, if necessary this nozzle can also pivot in steps and/or such that it can be locked into position by a locking collar (not shown).

The spray lance 1 has a feed line 10 leading from the handle 6 to the nozzle 7. In the shown example, this feed line is formed by an initial rigid pipe 11 and an attached flexible hose 12, which is attached to a connecting piece 13 for attaching the nozzle 7 or is attached directly to the nozzle 7, as can also be seen from the partial section enlargement cut-away according to FIG. 2.

Further, the spray lance 1 has a holding part 14, which is embodied rigidly, especially as an aluminum rod in the shown example. The holding part 14 holds a holding section 15, preferably loosely and so that it can pivot. On its side, the holding section 15 holds the feed line 10 in the region of the free end, especially the free end of the hose 12 and/or the connecting piece 13, and/or the nozzle 7, with the holding section 15 preferably being embodied like a collar or hose clamp and/or manufactured from plastic. In particular, the holding section 15 holds the feed line 10 and/or the nozzle 7 in a positive or force fit, so that the holding section 15 cannot move relative to the nozzle 7.

The nozzle 7 can be pivoted by longitudinal shifting of the holding part 14 and the feed line 10 relative to each other.

In the shown example, the handle 6 of the spray lance 1 is embodied elongated and extends in the direction of the longitudinal extension of the spray lance 1. In particular, it surrounds the feed line 10 or its pipe 11 at least in sections. Alternatively, however, the handle 6 can also be formed directly by the feed line 10, e.g., for a corresponding embodiment of the pipe 11, and/or can extend transverse to the longitudinal extension of the spray lance 1 and/or can be formed by the preferably provided valve pistol 3.

For relative shifting of the holding part 14 and the feed line 10, the spray lance 1 in the shown example has a handhold 16, which is associated to the handle 6 and which can move or be adjusted relative to this handle, if necessary, such that it can be locked into position. For example, the handle 6 is connected rigidly to the holding part 14 and guides the feed line 10 or its pipe 11 longitudinally, with the handhold 16 being allocated to the feed line 10 or to its pipe 11, in order to move the pipe 11 in the handle 6 and therefore to pivot the nozzle 7 in the desired way.

If the optional valve pistol 3 is present and connected rigidly to the feed line 10 or its pipe 11, this can also be used for generating the mentioned relative movement between the holding part 14 and the feed line 10 in the longitudinal direction in order to pivot the nozzle 7 in the desired way. In this case, the handhold 16 can be completely eliminated if necessary, or formed by the valve pistol 3.

In the shown example, the holding part 14 essentially extends along or parallel to the feed line 10 from the handle 6 to the nozzle 7. In the region of the free or nozzle-side end, the holding part 14 is preferably kinked, as shown in FIG. 1, especially in order to bend the hose 12 in a defined direction and thus to guarantee a defined pivoting behavior for the mentioned relative movement. The feed line 10 then preferably runs in the kink direction and on the opposite side of the holding part 14.

The metallic holding part 14 is preferably covered or coated at least in regions with an elastic and/or abrasion-resistant material, especially rubber or plastic. Preferably, a rubber hose or heat-shrink hose is applied.

The hose 12 of the feed line 10 is preferably protected by a helical screw-like spiral or the like against mechanical effects, especially excess abrasion of the hose jacket, and/or against kinks.

The spray lance 1 according to the proposal permits universal use, especially also the cleaning of objects or the like with an undercut in the insertion direction.

Another advantage of the spray lance 1 is that the nozzle 7 can be pivoted when the spray lance 1 is being used, thus during high-pressure cleaning. This is conducive to effective and quick cleaning.

Preferably, the nozzle 7 is spaced at least 50 cm from the handle 6. This is conducive to a high degree of user safety in order to prevent the main spraying direction 8 from being able to be directed at a user, not shown, of the spray lance 1 when the nozzle 7 is pivoted, or, if the cleaning stream is nevertheless directed at the user, to guarantee a safe distance between the nozzle 7 and the user.

According to a variant not shown, the holding part 14 can also form the feed line 10, especially formed as a hose.

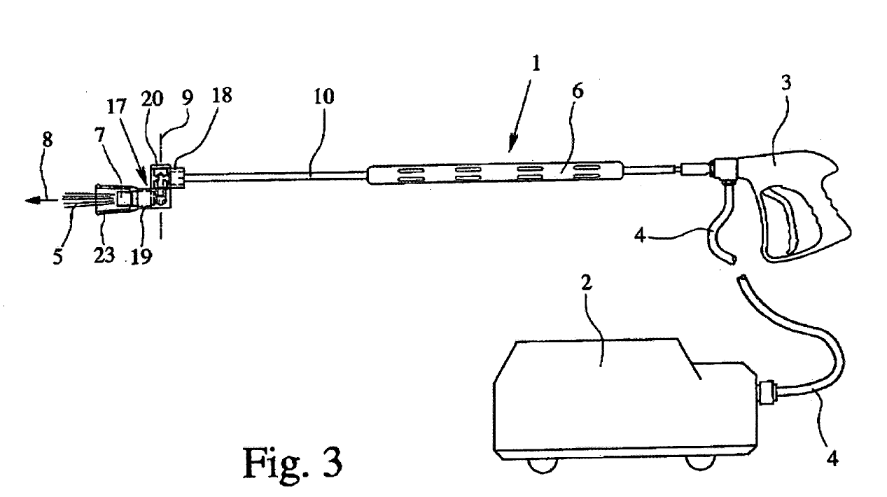

In the following, a second embodiment of the present invention is explained in more detail with reference to FIGS. 3-5, wherein, however, emphasis is essentially placed only on the differences from the first embodiment. Other configurations concerning advantages, aspects, characteristics, and features of the first embodiment apply correspondingly, as long as nothing else is given in the following description.

FIG. 3 shows the spray lance 1 according to the second embodiment with the handle 6, which is attached to the feed line 10, which leads to the nozzle 7. Here, the feed line 10 is preferably embodied as a rigid pipe, which is embodied either straight or optionally kinked.

According to the proposal, the nozzle 7 is attached via a link 17 to the feed line 10. Correspondingly, the nozzle 7 and thus the main spraying direction 8 can pivot about the pivoting axis 9, which runs transverse, especially perpendicular, to the longitudinal extension of the spray lance 1, the feed line 10, and/or the main spraying direction 8 of the nozzle 7.

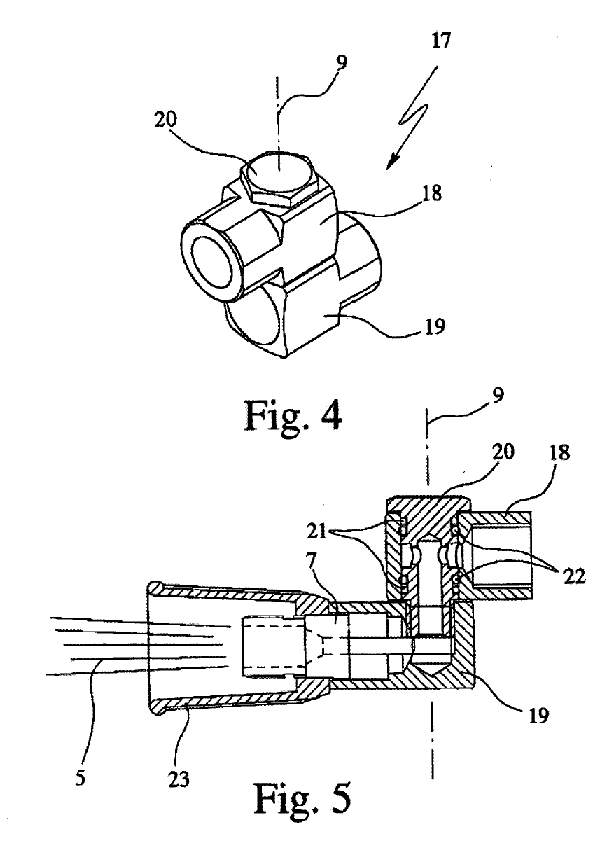

FIG. 4 shows the link 17 in a perspective view without a feed line 10 and without nozzle 7.

FIG. 5 shows the link 17 in a schematic section along the longitudinal extension of the spray lance 1.

The link 17 is embodied in the shown example as a nozzle holder, because the nozzle 7 can be connected detachably to the link 17, thus, e.g., can be replaced for repair purposes or for adapting to cleaning tasks. However, the nozzle 7 can alternatively also be integrated directly in the link 17 or can form one structural unit with this link.

The link 17 according to the proposal has a first attachment part 18 for connecting to the feed line 10, especially by means of a thread.

The link 17 further has a second attachment part 19 for receiving or holding the nozzle 7. Alternatively, the nozzle 7 can also be integrated into the second attachment part 19 or connected rigidly to this attachment part.

Both attachment parts 18, 19 are connected so that they can pivot relative to each other about the pivoting axis 9, especially by means of a screw 20. Preferably, the screw 20 is embodied as a hollow screw, which is simultaneously used for fluid connection of the two attachment parts 18, 19 and thus for a fluid connection of the feed line 10 to the nozzle 7.

It can be seen from the sectional illustration according to FIG. 5 that in the shown example, the first attachment part 18 is penetrated by the screw 20 and the screw 20 is screwed into the second attachment part 19. Consequently, no nut or the like is required for securing the screw.

The first attachment part 18 can pivot about the screw 20 connected rotationally fixed to the second attachment part 19, with the position and desired seal being guaranteed by sealing ring 22 with or without support ring 21 between the screw 20 and the first attachment part 18.

In the shown example, the two attachment parts 18, 19 can pivot by 360° relative to each other. However, the pivoting range of the link 17, thus of the two attachment parts 18, 19, can also be limited, preferably corresponding to the details on the first embodiment.

Instead of limiting the pivoting motion, the link 17 can also be embodied such that when a predetermined pivoting range is exceeded, especially when the two attachment parts 18, 19 approach a pivot position, in which they point in the same direction, the possible passage of cleaning fluid 5 in the link 17 is interrupted.

In addition, or as an alternative, to the mentioned pivoting limit, the nozzle 7 can also be surrounded by a so-called, preferably conical nozzle protector 23, which represents in the mounted state a pivoting limit, so that, in particular, the main spraying direction 8 can be prevented from pointing back towards the handle 6 parallel to the feed line 10.

The link 17 is preferably embodied such that pivoting occurs only with relative difficulty, so that the nozzle 7 does not change its pivot position automatically or undesirably when it is used, thus during high-pressure cleaning. This desired difficulty is achieved in the shown example by a corresponding press fit of the sealing ring 22 with or without support ring 21.

According to an especially preferred variant, the link 17 or the nozzle 7 cannot pivot due to the pressure of the cleaning fluid 5 during a cleaning process. Instead, the pivoting is then automatically blocked, for example, by the increased pressure pressing seals 22 against attachment parts 18 and 19 to increase frictional resistance to pivoting.

The link 17 is preferably manufactured at least essentially from metal, so that a high degree of durability and stability both in terms of mechanical and also thermal properties can be achieved.

It is to be noted that preferably a nozzle protector 23 is also allocated to the nozzle 7 in the first embodiment.

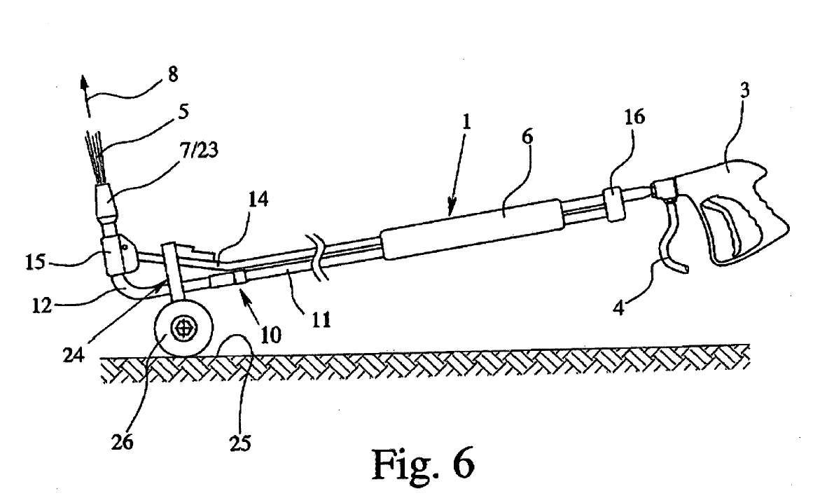

In a schematic illustration, FIG. 6 shows a third embodiment of the spray lance 1 according to the proposal. The spray lance 1 has in the region of its front or free end a support device 24 in order to be able to support the spray lance 1 on a floor surface 25 or the like.

The support device 24 can be embodied, e.g., as a sliding block or the like. In the shown example, the support device 24 has at least one roller or a wheel 26, preferably two wheels 26 spaced transverse to the longitudinal extension of the spray lance 1. An appropriate spacing of the wheels 26 provides good stabilization of the spray lance 1 against lateral tipping. The spray lance 1 can be held and guided very easily and with minimal expenditure of force just at the valve pistol 3.

In the shown example, the rotational axis runs preferably fixed, namely transverse, especially perpendicular, to the longitudinal extension of the spray lance 1. The rotational axis of the wheels 26 here also runs preferably transverse to the main spraying direction 8, which is angled on its side relative to the longitudinal extension of the spray lance 1 and preferably, but not absolutely necessarily, can pivot corresponding to the first embodiment. However, if necessary, it can also be just a rigid, thus non-adjustable angle of the main spraying direction 8 relative to the longitudinal extension of the spray lance 1.

If necessary, the rotational axis can also pivot relative to the spray lance 1. In this case, the rotational axis is linked by means of a not shown link, such as a universal joint or the like, to the support device 24.

The support device 24 is preferably fixed to the spray lance 1 so that it can be detached or disassembled, e.g., by clamps, screws, or the like. In the shown example, the support device 24 is attached to the holding part 14. Alternatively, the support device 24 can be attached to the feed line 10.

According to a not shown variant, the support device 24 itself can also fold or pivot in order to be moved into a usable position, e.g., for cleaning the underbody of a motor vehicle, and into less disruptive non-usable positions as much as possible for other cleaning purposes.

The spray lance can be used very universally for cleaning work, especially both in private households and also in the industrial sector.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A spray lance for a high-pressure cleaning device, especially for cleaning fluid, wherein the spray lance is elongated and has a handle and an associated nozzle, wherein the nozzle can pivot about a pivoting axis transverse to its main spraying direction, especially transverse to at least one of the longitudinal extension of the spray lance and the handle.

2. Apparatus as claimed in claim 1, wherein the nozzle can also pivot during high-pressure cleaning.

3. Apparatus as claimed in claim 1, wherein the pivoting position of the nozzle can be fixed, especially exclusively, by the pressure of the cleaning fluid.

4. Apparatus as claimed in claim 1, wherein the nozzle can pivot only to a limited extent, so that the main spraying direction of the nozzle cannot point towards the handle.

5. Apparatus as claimed in claim 1, wherein the nozzle can pivot up to a maximum of 140°, preferably up to approximately 120°, starting from the main spraying direction when the nozzle is not pivoted.

6. Apparatus as claimed in claim 1, wherein the nozzle can pivot continuously.

7. Apparatus as claimed in claim 1, wherein the pivoting axis runs adjacent to the nozzle or through the nozzle.

8. Apparatus as claimed in claim 1, wherein the spray lance is flexible in the region of its free end.

9. Apparatus as claimed in claim 8, wherein the spray lance has a feed line leading from the handle to the nozzle, said feed line having a rigid portion connecting to a flexible portion adjacent its free end.

10. Apparatus as claimed in claim 9, wherein the handle is elongated and/or extends in sections along the feed line.

11. Apparatus as claimed in claim 9, wherein the spray lance has a preferably rigid holding part, which holds and/or guides the nozzle and said feed line leading to the nozzle so that it can pivot.

12. Apparatus as claimed in claim 11, wherein the nozzle can pivot through relative shifting of the holding part and the feed line.

13. Apparatus as claimed in claim 12, wherein the holding part is connected to the handle.

14. Apparatus as claimed in claim 11, wherein the holding part preferably loosely holds a holding section so that it can pivot, which holds the nozzle and/or the feed line, especially directly next to the nozzle, in a force or positive fit.

15. Apparatus as claimed in claim 11, wherein the spray lance has a handhold or valve pistol for pivoting the nozzle and associated especially to the handle.

16. Apparatus as claimed in claim 15, wherein the handle or valve pistol can move or be adjusted relative to the handle for pivoting the nozzle, if necessary such that it can be locked in position.

17. Apparatus as claimed in claim 1, wherein the spray lance has in the region of its front end, a support device for support on a floor surface, especially wherein the main spraying direction can be directed away from the floor surface.

18. Apparatus as claimed in claim 17, wherein the support device is fixed to the spray lance so that it can be detached or disassembled and/or the support device has at least one wheel for guiding or rolling on the floor surface.

19. Apparatus as claimed in claim 1, wherein the spray lance has a link in a preferably otherwise rigid feed line from the handle to the nozzle or in the nozzle.

20. Apparatus as claimed in claim 19, wherein the link is embodied as a nozzle holder.
